(19) United States
(12) Patent Application Publication
(10) Pub. No.: US 2020/0267183 A1
(43) Pub. Date: Aug. 20, 2020

(54) SYSTEMS AND METHODS FOR VULNERABILITY ANALYSIS OF PHISHING ATTACKS

(71) Applicant: Avant Research Group, LLC, Buffalo, NY (US)

(72) Inventor: Arun Vishwanath, Buffalo, NY (US)

(73) Assignee: Avant Research Group, LLC, Buffalo, NY (US)

(21) Appl. No.: 16/791,416

(22) Filed: Feb. 14, 2020

Related U.S. Application Data
(60) Provisional application No. 62/806,651, filed on Feb. 15, 2019.

(51) Int. Cl. H04L 29/06; G09B 19/00

(52) U.S. Cl. CPC H04L 63/1483; H04L 63/1433; H04L 63/1416; G09B 19/00; H04L 63/0236; H04L 63/102; H04L 63/20

(57) ABSTRACT

Various embodiments provide a systems and method to manage creation of pen-tests in conjunction with scoring on multiple vertices to establish a consistent measure of level of difficulty associated with the pen-test. The system may manage execution of the pen-test with a sample group selected from a test target to establish a baseline score that other users of the broader target can be expected to meet or can be graded against. According to various embodiments, tailored scoring (e.g., specific to an entity) yields a more accurate measure for evaluating vulnerability relative to conventional approaches. Users having high risk scores can be required to complete targeted training exercises and/or repeat pen-test evaluations until their scores improve. In some embodiments, user permissions, rights, and/or roles on their computer systems can be automatically adjusted to increase security. Any adjustments may be automatically reversed responsive to completing training and/or improving a risk score.

### RELATED APPLICATIONS

This application claims priority under 35 U.S.C. § 119(e) to U.S. Provisional Application Ser. No. 62/806,651 entitled “SYSTEMS AND METHODS FOR VULNERABILITY ANALYSIS OF PHISHING ATTACKS,” filed on Feb. 15, 2019, which application is incorporated herein by reference in its entirety.

### BACKGROUND

Phishing is one of the most virulent threats to cyber security. Organizations worldwide presently spend billions of dollars on anti-phishing prevention and even more on mitigating losses from breach due to phishing. Such expenditures are only expected to increase as phishing attacks increase in sophistication and as organizations continue to be unable to plug the organizational weaknesses that reduce the effectiveness of this attack vector.

To date, conventional technological fixes ranging from whitelisting tools to hardware based solutions have had limited success with stopping phishing. Even conventional training efforts have done little to stem phishing. Most conventional training involves a simulated phishing attack, where users are sent a phishing email and then shown why they fell prey to it. The protocol involves embedding a “splash page” in the phishing email either within a hyperlink or attachment, which displays the facets of the phishing email that the user missed. Failure on the pen-test, i.e., if and how many individuals click on the phishing test, is then used as the diagnostic of phishing vulnerability and organizational readiness/resilience against phishing. This form of training is by far the most popular with a cottage industry of security training companies providing various packed training services that in essence replicate this protocol.

### SUMMARY

The inventors have realized that because phishing attacks utilize social engineering techniques to entice users to click on malicious links and attachment, conventional approaches (e.g., whitelisting, etc.) and conventional identification systems will not address the problem. As phishing links are sent via email and social media messages (which form the backbone of online communication) stopping the use of these modalities or even screening of all messages is not possible. Recognizing this, the focus of much of today's cyber security efforts has been on improving user awareness through security training so as to improve their resilience against phishing. However, training (usually the same form of training) is doled out to all users often repeatedly, and all without an assessment of the reasons behind the users' susceptibility to phishing.

Conventional training approaches are analogous to a physician summarily prescribing a medication without once diagnosing a patient. Making matters worse, all patients are provided the same medication (in the phishing case, this medicine is user training) and if the medication doesn't work, more of it is prescribed. Thus, missing from almost all these approaches is an understanding of why people fall victim to spear phishing. That is beyond knowing who clicked on a phishing test, there is no diagnostic or detail about the quality of the phishing test (i.e., was the attack so hard that no one could have reasonably detected it?), its appropriateness (i.e., how many users in that organization given their prior training or other experiences should have recognized its deception?), or the reasons why the users who fell for it did so (i.e., was this an accidentally click, a lack of understanding, or a lack of ability?).

Various aspects and embodiments provide quantitative analysis of the reasons for users' being vulnerable to spear phishing attacks, as well as system and/or architecture that determine vulnerability to phishing attacks. For susceptible users, the system can be configured to intervene automatically to address the security risk posed by such users, until target training can be used to address the underlying vulnerability reasoning.

According to various aspects, the system manages creation of penetration tests (“pen-test”) in conjunction with scoring on multiple vertices (e.g., apparent source indicia scoring, routine match score, heuristic score, among other options discussed in greater detail below) to establish a consistent measure of level of difficulty associated with the pen-test. According to further aspects, the system further manages execution of the pen-test with a sample group selected from a test target (e.g., corporation, department, users of certain architecture, etc.). The sample execution is used to establish a baseline score that other users of the broader target can be expected to meet or can be graded against. In some examples, a sample set is made up of IT personnel, and their performance is used to set the target level of performance, for example, with the baseline score. In further aspects, the inventors have realized that a locally customized score (e.g., sampled performance information from the target) provides a more accurate methodology for evaluating vulnerability, and provides accuracy that is far superior to existing solutions. In other embodiments, historic performance can be used to set a baseline score, and hybrid scores can be developed using historic performance and locally customized values.

In further embodiments, users identified as risky or having risky behaviors can be required to complete targeted training exercises and/or repeat pen-test evaluations until their scores improve. In some embodiments, user permission, rights, and/or roles on their computer systems can be automatically adjusted to increase security filtering, limit exposure to computer vulnerability, block sites, limit access to whitelist web-sites, etc. The adjustment may be automatically reversed responsive to completing training and/or improving a risk score on subsequent pen-tests.

According to one aspect, a system for identifying vulnerability to phishing attacks is provided. The system comprises at least one processor operatively connected to a memory storing instructions, the instructions when executed cause the at least one processor to perform functions to manage generation of a penetration test (“pen-test”), evaluate the pen-test during generation, wherein evaluation of the pen-test includes functions to score the pen-test on a plurality of factors, execute the pen-test on a sample of users, collect evaluations of the pen-test from the sample of users, generate a baseline score for a user population based on the collected evaluations, execute the pen-test on the user population different than the sample of users, identify underperforming users within the user population as not meeting the baseline score, and execute custom training on the underperforming users.

According to one embodiment, the system executes subsequent pen-tests on the user population and evaluates performance of the underperforming users responsive to executing targeted training to improve performance. According to one embodiment, the system is configured to correlate underperforming users and identify reasoning for underperformance based on user survey responses. According to one embodiment, the system is configured to select training options correlated with the reasoning for underperformance. According to one embodiment, the system is configured to determine an efficacy of the training options based on subsequent executions of pen-tests. According to one embodiment, the system is configured to automatically select different training options based on determining insufficient improvement over time.

In some embodiments, various thresholds can be statically defined on the system for improvement. In other embodiments, dynamic thresholds can be determined based on analysis of similar users (e.g., having similar risk scores, reasoning for risk scores, etc.). In yet other embodiments, the system can dynamically define thresholds based on test re-execution with the sample population, among other options. According to one embodiment, the plurality of factors include: (i) how credible is a sender of an email to the end-user; ii) how easily identifiable are cues indicating credibility of a source; and iii) how routine does a request appear in context of an organization. According to one embodiment, the at least one processor is further configured to automatically update security permissions on accounts associated with underperforming users.

According to one embodiment, the at least one processor is further configured to automatically update browser privileges for respective underperforming users including at least one of increasing security filtering for web browsing, limiting access to whitelist websites, or preventing access to blacklist websites. According to one embodiment, the at least one processor is further configured to automatically update application privileges associated with respective underperforming users including at least one of increasing security settings for e-mail filtering, increasing periodicity of virus scanning, activating port monitoring on respective underperforming users, activating behavior profiling, increasing frequency of any monitoring, isolating e-mail attachments to prevent executable function, or monitoring for executable functions triggered by e-mail attachments. According to one embodiment, the at least one processor is further configured to restore security permissions responsive to user completion of identified training operations. According to one embodiment, the at least one processor is further configured to restore security permissions responsive identifying a risk score improvement meeting a threshold level.

According to one aspect, a computer implemented method for identifying vulnerability to phishing attacks is provided. The method comprises managing by the at least one processor the generation of a penetration test (“pen-test”), evaluating by the at least one processor the pen-test during generation (wherein evaluation of the pen-test includes scoring by the at least one processor) the pen-test on a plurality of factors, executing by the at least one processor the pen-test on a sample of users, collecting by the at least one processor evaluations of the pen-test from the sample of users, generating by the at least one processor a baseline score for a user population based on the collected evaluations, executing by the at least one processor the pen-test on the user population different than the sample of users, identifying by the at least one processor underperforming users within the user population as not meeting the baseline score, and executing by the at least one processor custom training on the underperforming users.

According to one embodiment, the method further comprises executing subsequent pen-tests on the user population and evaluating performance of the underperforming users responsive to executing targeted training to improve performance. According to one embodiment, the method further comprises correlating underperforming users and identifying reasoning for underperformance based on user survey responses. According to one embodiment, the method further comprises automatically selecting training options correlated with the reasoning for underperformance. According to one embodiment, the method further comprises determining an efficacy of the training options based on subsequent executions of pen-tests. According to one embodiment, the method further comprises automatically selecting different training options based on determining insufficient improvement over time. According to one embodiment, the at least one processor is further configured to automatically update security permissions on accounts associated with underperforming users.

According to one embodiment, the at least one processor is further configured to automatically update browser privileges for respective underperforming users including at least one of increasing security filtering for web browsing, limiting access to whitelist websites, or preventing access to blacklist websites. According to one embodiment, the at least one processor is further configured to automatically update application privileges associated with respective underperforming users including at least one of increasing security settings for e-mail filtering, increasing periodicity of virus scanning, activating port monitoring on respective underperforming users, activating behavior profiling, increasing frequency of any monitoring, isolating e-mail attachments to prevent executable function, or monitoring for executable functions triggered by e-mail attachments. According to one embodiment, the at least one processor is further configured to restore security permissions responsive to user completion of identified training operations. According to one embodiment, the at least one processor is further configured to restore security permissions responsive identifying a risk score improvement meeting a threshold level.

### BRIEF DESCRIPTION OF THE FIGURES

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example assessment system, according to one embodiment;

FIG. 2 is a conceptual diagram of scoring metrics, according to one embodiment;

FIG. 3 is a block diagram showing elements for scoring users as part of vulnerability analysis, according to one embodiment;

FIG. 4 is a block diagram of an example embodiment of an assessment system, according to one embodiment;

FIG. 5 is a block diagram of example system components and example process flow for generating a risk assessment, according to one embodiment;

FIG. 6 is an example logical flow for developing training options based on user risk assessment, according to one embodiment;

FIG. 7 is a block diagram of example approaches for identifying high risk users and training options, according to one embodiment; and

FIG. 8 is a block diagram of an example a distributed system, according to some embodiments.

### DETAILED DESCRIPTION

Stated generally, various aspects and embodiments provide quantitative analysis of the reasons for users' being vulnerable to spear phishing attacks, as well as system and/or architecture that determine vulnerability to phishing attacks. According to various aspects, the system manages creation of penetration tests (“pen-test”) in conjunction with scoring on multiple vertices (e.g., apparent source indicia scoring, routine match score, heuristic score, among other options discussed in greater detail below) to establish a consistent measure of level of difficulty associated with the pen-test. According to further aspects, the system further manages execution of the pen-test with a sample group selected from a test target (e.g., corporation, department, users of certain architecture, etc.). The sample execution is used to establish a baseline score that other users of the broader target can be expected to meet or can be graded against. In some examples, a sample set is made up of IT personnel, and their performance is used to set the target level of performance, for example, with the baseline score. In further aspects, the inventors have realized that a locally customized score (e.g., sampled performance information from the target) provides a more accurate methodology for evaluating vulnerability, and provides accuracy that is far superior to existing solutions. In other embodiments, historic performance can be used to set a baseline score, and hybrid scores can be developed using historic performance and locally customized values.

In some aspects, the generated pen-test can be associated specifically with the why users fell prey to the simulated attack. This capability is not available in conventional approaches. In some embodiments, tailoring education to the why users fell prey results in improved training and greater improvement in subsequent performance on different pen-tests. In further embodiments, subsequent executions and monitoring can be used to improve user education and to customize training that addresses the why as well as customizing the training to what achieves the greatest improvement over time (for example, conventional systems do not provide this functionality).

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Various embodiments involve creation and execution of baseline spear phishing attacks and various iterations of spear phishing using a vulnerability model (including, for example a human vulnerability model). In one example, a model framework (e.g., Vishwas Model framework) provides association between attack modes and vulnerability. According to various embodiments, using the framework, the proposed system GUI guides IT managers (e.g., through simulation generation options, heuristics, rules, and examples, among other options) into developing appropriate phishing attacks that have the constituent elements necessary for generating valid attack simulations (e.g., pen-tests). According to some embodiments, the system allows the IT managers to assess the appropriateness of each pen-test. In one example, the system analyzes an attack simulation as it is being generated, scoring each component to facilitate the creation of a valid and consistent attack with consistent or known levels of difficulty.

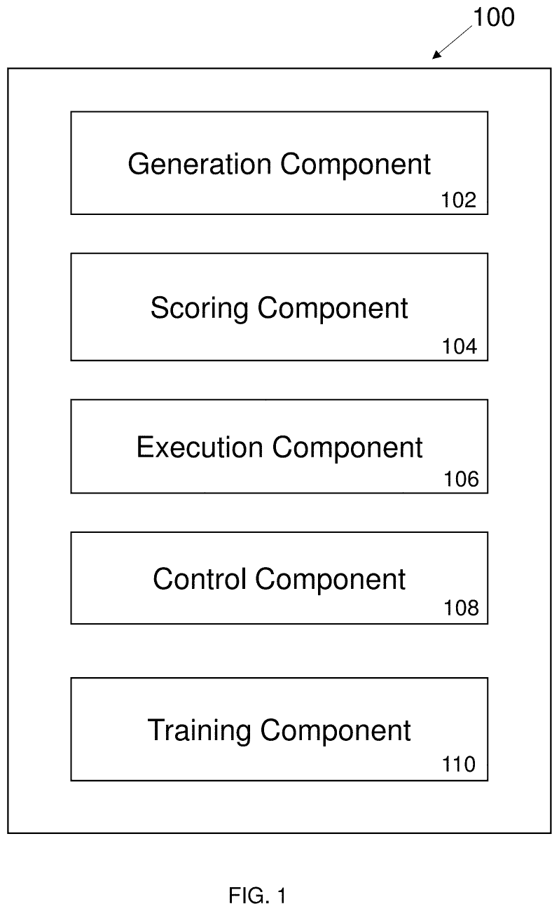

FIG. 1 is a block diagram of an assessment system configured to identify vulnerability to phishing attack. According to various embodiments, the system can include generation component 102 configured to manage generation of a pen-test. The generation component can guide IT users and/or administers through creation of an initial pen-test. The test may be tailored to a specific entity and/or group of users. In one example, the administrators can identify target goals for improving security and the generation component can be configured to guide the users through selection of specific tests that facilitate achieving those goals. In further example, a goal of improving awareness of attachment vulnerability can cause the system to select and/or focus users to testing scenarios involving malicious attachments. Once a tailored baseline score is established, the various scenarios can be executed against a broader user populations, include for example, a user base at a company.

In various embodiments, a scoring component 104 is configured to dynamically adjust scoring of any test. In some examples, the same exact test is scored by the system differently between different user populations. In some embodiments, the scoring component 104 can be configured to execute a generated pen-test with a scoring population. For example, the IT staff can be used a model for determining a baseline score for a given pen-test. In some embodiments, the scoring component 104 can invoke and/or work in conjunction with an execution component 106 to run the pen-test against the scoring population.

According to some embodiments, the scoring component 106 can be configured to collect results of the pen-test from the scoring population to establish a baseline score and/or scoring parameters for a larger population. Once the baseline score and/or scoring parameters are established an execution component 106 can be configured to run the pen-test against a different user population. Based on the results of the pen-test on the different population, high risk users can be identified (e.g., relative to the baseline group of users). Generally, once high risk users are identified, the system can tailor training regimens automatically to the high risk users. For example, a training component can be configured to automatically select training materials relevant to vulnerability assessments of the high risk users. In various examples, user can be identified as high risk in a variety of operational areas base on the tailored scoring approach. Similarly, training material can be tailored and/or selected to specifically target respective user's weaknesses. In some embodiments, risk threshold can be established for respective scores. In one example, deviation metrics from the baseline scores can be used to establish thresholds. User scores exceeding a number of deviation can be subject to automatic system operation. In some examples, the system can be configured to lock users out of respective computers and/or applications until a selected training regimen has been started, or finish by the user.

In some embodiments, the system can include a control component 108 configured to manage automatic actions for respective users. In some examples, the control component 108 can determine if various thresholds are exceeded and select automatic remediation accordingly. According to one embodiment, the system/control component 108 can be configured to limit a user's permissions on their respective computer systems responsive to exceeding a threshold. The control component 108 can be configured to manage execution of training sessions and restoration of the user's permissions, once complete. In other embodiments, restoration of permissions and/or access may be limited to improving a respective vulnerability score.

In further example, the control component can manage updating security permissions on accounts associated with underperforming users, lock access to sites based on vulnerability of respective users, increase security filter level (including for example, web browsing) based on vulnerability of respective users, increase security level of e-mail filter settings based on vulnerability of respective users, increase periodicity of virus scanning, activate port monitoring on respective risky users, activate user behavior profiling based on vulnerability of respective users, increase frequency of same based on vulnerability of respective users, and/or sandbox e-mail attachments for most risky users (e.g., so that attachments cannot execute malicious code regardless of whether the attachments are opened).

In various embodiments, the system is configured to establish a score for an attack simulation based on responses provided by a small sample of experts selected by the IT manager. In further examples, each attack simulation includes an embedded set of survey questions, which can be delivered with the attack simulation to allow the system to accurately and consistently score all generated attack simulations. In still other examples, the system includes sample short survey questions (e.g., three-fifteen questions) embedded within each phishing pen-test. Using the responses from the sample population to the short survey, a cut-off value or ideal score is determined for the attack in advance of the attack being deployed, for example, to an organization.

In another example, the system samples from returned information to establish a base-line score (e.g., sample or sub-sample from identified experts, characteristic users, etc.). In yet other examples, the system can re-evaluate or update a score for a pen-test as actual execution information is collected. The modified scoring information can be used, in some embodiments, to score subsequent tests and/or to weight returned information from expert evaluation.

According to various embodiments, the system executes the attack(s). Once the phishing attack(s) are executed (e.g., within an organization), the targeted users/personnel can be required to respond to framework questions, which link particular phishing attacks to vulnerability ratings. For example, users are required to fill out a short survey (e.g., 15, 20, 30, 40, 50, 60 question survey, among other options (e.g., 20-30) shortly after the attack. In other examples, surveys can be communicated with a week or two of the simulation. In another example, any person who does not fall for the phish is sent a separate survey with the same set of questions but with a few additional questions after the attack is completed (e.g., a greater time delay can be implemented with passing users—usually within a week).

According to various embodiments, the model and questions are designed to measure the core cognitive-behavioral factors that lead to individual phishing victimization as determined by the suspicion, cognition, automaticity model (“SCAM”) discussed in greater detail herein. In various embodiments, the survey question responses are analyzed and/or weighted based on the SCAM based parameters and the cut-off score or ideal score.

According to various embodiments, the system is configured to analyze the survey questions, incorporate weighting values for the questions based on the SCAM parameters and the cut-off score. In one example, the responses to the survey questions are weighted using a multivariate regression analysis, where the responses to the cognitive-behavioral questions are regressed onto the question measuring level of suspicion to evaluate the relative statistical significance and contribution of each cognitive-behavioral measure in explaining user susceptibility.

In various embodiments, the system is configured to generate an individual cyber risk index (CRI) score. In some embodiments, the index score is generated for each individual and can range from 0-100, with higher numbers indicating more relative risk (in other examples, different ranges can be used as well as different correlations between high and low values). According to one embodiment, the index score for each individual is compared to the idealized/optimized cut-off provided by the IT expert sample. According to various embodiments, the system is configured to categorize various analyzed individuals into a plurality of risk categories. According to one embodiment, the system generates a quantitative score that represents and helps explicate the specific cognitive or behavioral factors that made the individual risky. For example, the system analyzes the assigned risk categories, and the submitted responses to the pen-test survey to generate a quantitative score and any details for the specific cognitive or behavioral factors (e.g., how much cognitive processing effort the user exerted, the types of heuristics they used, the amount/extent of cognitive elaboration the engaged in; their email use habits and related factors such as their ability to self-regulate and their email use patterns, and such) that made the individual risky.

In some embodiments, the system is configured to use the CRI score to identify the high vs. low risk individuals in the organization and use the differences in their responses to the SCAM survey questions to identify the reasons for their higher risk. For each user in the organization, the system's GUI is configured to display details on an individual user, and includes a display that highlights the overall CRI score for the individual and the individual's risk level. In further examples, the user interface can also display the specific cognitive-behavioral predictors of the CRI score on which the user exceeded or failed to exceed the benchmark score (e.g., the difference in how much cognitive effort was put in, if/and how many heuristics were used, differences in email use habits, differences in email checking/responding rituals and such, among other options). In one example, the system analyzes a regression equation with includes variables for cognitive effort (e.g., heuristics, systematic processing, risk beliefs)×variables for habits (e.g., DSR, patterns, device) and yields a suspicion/CRI score. Execution of the regression identifies statistically significant predictors. In further embodiments, the system can be configured to automatically adjust security settings for high risk users, and mange return of security privileges responsive to completing training and/or attaining better scores.

According to some embodiments, cognitive effort can be analyzed by the system as a cognitive-behavioral predictor. Given a scenario where most low risk users (identified using their CRI score), put in statistically significant cognitive effort in order to identify the pen-test as suspicious (e.g., identified based on the regressions), their score on that factor can be used by the system to establish underperforming patterns in high risk users. In one embodiment, the system is configured to compare how much cognitive effort is made by low risk vs high risk users by averaging the responses of all low risk individuals on the measure for cognitive effort and identifying how much the high risk individuals deviated in their responses on that metric. In some embodiments, the system is configured to define the degree to which the cognitive effort of the high risk users is lacking. In some examples, this analysis is presented in the user interface using a color coding system that ranges from green to different hues of red. In another example, the system identifies patterns of user habit among low risk individuals, and correlates those behaviors to the why low risk users are low risk (for example, using regression analysis). The system is configured to compare those correlated behaviors and scoring of low risk use to corresponding behaviors of the high risk users. A similar color scale can be used to display habit based analysis showing from green (low risk) to red (high risk) in the user interface.

In further embodiments, once the system generates the quantitative score and the diagnosis using color coded flags, the system determines the types of interventions, ranging from increased education to pattern change/behavioral modification training, that would help reduce the users' future vulnerability from phishing. According to some embodiments, GUI elements in the system corresponding with the color-coded diagnosis is configured to open a window on which different suitable interventions are presented. In some examples, the system, selects optimal matches to specific training options (e.g., options that have had the most success with other similar users, score the most relevant, etc.). According to one example, if the user is lacking cognitive effort, a series of interventions from education to different quizzes are suggested, where the system is configured to select the interventions from options tagged with cognitive effort training. In further examples, the system can automatically order options within the intervention classifications, for example, based on analysis of subsequent executions and greatest improvements in scores over time. In yet other embodiments, the system can automatically revoke user access privileges and only restore privileges upon successful completion of training.

In other examples, if the user is high risk in habitual reactivity, the system automatically selects training options associated with cognitive practices or ritual which are tailored to improve mindfulness. In some embodiments, the system is configured to provide interventions which may also lead to clickable links to external websites or various vendors for the solutions to the specific deficiency in the user. As discussed above, the system can track the efficacy of the provided options (e.g., whether user engaged with intervention/education, which ones, and how effective they were (e.g., improvement in performance over time, etc.)). Further, the system can automatically enforce privileged restrictions until such training is complete.

As discussed, in various embodiments, the system is configured to monitor test executions over time and correlate improved CRI scores with specific education and/or training approaches. For example, once the user is provided a certain intervention, the system may access education coding (e.g., tags for type of training or intervention, or classification based on risk category, etc.). In some examples, IT managers can code the type of training or intervention that was selected. When the user is tested again, using a subsequent pen-test, the user's CRI scores can be compared to the scores from the previous iteration(s). For example, the individual users' performance on the subsequent test are compared to that of their first test and any differences in performance, after accounting for changes in test difficulty, are contrasted and attributed to the intervention.

Further embodiments can employ the correlated improvements to identify learning pathways that are more effective for given vulnerabilities and for given organizations. For this, the improvements in CRI and performance across diagnosed weaknesses at the aggregate organizational level is compared before and after various interventions to assess if the entire organization has shown an improvement because of a certain intervention or if only certain individuals have shown improvements or remained weak.

According to various aspects, assessment systems can change conventional implementation and/or approaches beginning with a diagnosis of what ails the patient, i.e., the user, and culminates with a quantitative diagnostic of the user's cyber health. According to one embodiment, this diagnostic includes a CRI score, which is an individualized risk score (e.g., that ranges for 0-100) specifying the individuals' spear phishing risk as well as the reasons for this risk that is generated by the system. For example, these procedures (e.g., executed by the system) for developing the appropriate phishing test, performing the a priori diagnosis of the test's quality and users expected performance, the tools used for the diagnosis of users' resultant performance, and the algorithm used to come up with the final CRI are not available in conventional implementation, and provide new functionality unavailable in conventional older systems.

Example Execution for Risk Assessment

According to one embodiment, the approach for developing a CRI begins with a simulated phishing attack. While some known approaches conduct phishing attacks, there is no theoretical rationale for how these attacks are crafted and executed. These approaches and their attacks are, therefore, ad-hoc. For example, such ad-hoc testing can be crafted by the IT security staff using some personal ideas about user phishing susceptibility. This results in the simulated attacks being either too obvious or too complex. The inventors have realized that using such conventional simulated attacks as a baseline against yields a flawed assessment for individual cyber readiness or organizational resilience against phishing. Therefore any score developed from such ad-hoc approaches is unreliable as a metric of organizational resilience. This problem is further complicated when comparing subsequent attacks, all of which are likewise crafted in such an ad-hoc manner, which leads to widely unreliable findings. Another failure of conventional approaches involves users becoming familiar with the types of simulations (e.g., attack emails) being used by the IT department—which further reduces the validity of the tests as any measure of phishing susceptibility. Another issue with conventional approaches stems from using the metric of failure (i.e., as in the number of individuals who clicked on the simulated phishing attack) as the metric of individual or organizational readiness. The metric of failure provides no information on why individuals clicked or didn't click on the attack. Such an approach is analogous to assuming that all car accidents in a street are because of drivers who all don't know how to drive.

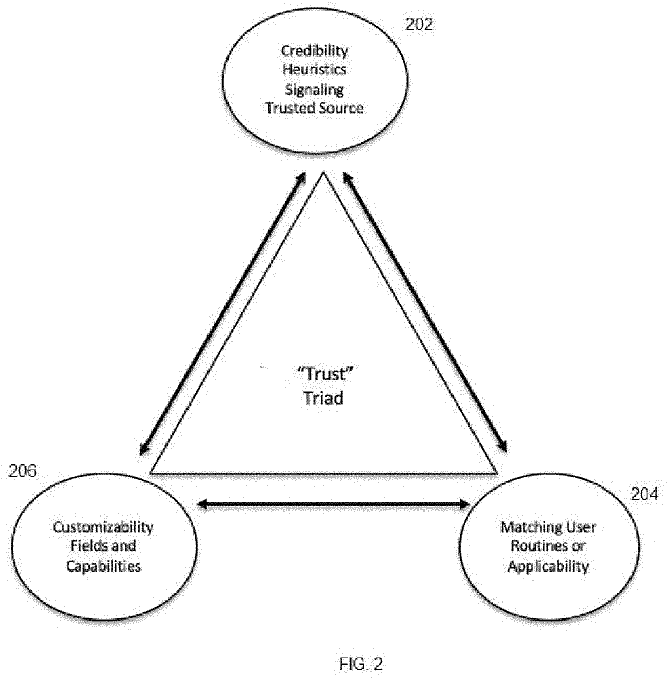

According to various embodiments, the proposed approach is distinct as it evolved from a consistent approach for crafting a simulated phishing email. The foundation stems from a model balancing multiple factors. One example model is referred to Vishwas Triad. Vishwas is a Sanskrit word that means Trust. In some examples, the Vishwas triad quantifies/provides (e.g., the 3-4) facets of trust that are then used by the system to manage development of a baseline phishing email, and for example, that the average user within that organization might trust as being authentic. An example triad is shown FIG. 2 and provides a conceptual visualization of consistent scoring approaches. One element of the score can include evaluation of the credibility of the attack or whether a user will perceive the attack as not out of the ordinary (e.g., 202).

Another element of the score can include how well the attack matches user routines or how applicable the attack vector is the user's role or responsibility 204. Yet other elements can include a scoring of how customized an attack is, e.g., customizability fields and capabilities (e.g., 206).

Stated generally, a trust triad establishes qualitative thresholds for analysis, where a baseline phishing email should achieve a threshold score (e.g., an average score on a scale of 1-5). For example, the score can be derived in response to the following questions: (i) How credible is the sender of the email to the end-user? (ii) How easily visible are the cues indicating credibility of the source? (iii) How routine is it for someone in the organization to receive such an email/request? According to various embodiments, an average attack (e.g., meeting a threshold score and in some examples not exceeding another threshold (i.e., sufficiently complex but not overly hard)) is crafted by the system using GUI elements on each vertex that when clicked lead to exemplars of heuristic source cues, scripts of user routines/expectations, and trust sources, which when selected allow the IT manager to craft a phishing test that combines the elements necessary for the development of an ideal phishing test attack. In some examples, as the user generates attack parameters, the system provides real time feedback on the scoring of the attack. For example, the system dynamically scores a generated attack during creation and provides visual feedback on scoring within a triad visualization. Thus, the user interface and feedback displays, enable users to generate attacks having a qualitative level of difficulty and do so consistently, with real time visual confirmation. Other scoring presentations can be provided.

In some embodiments, each addition of a testing element and/or question is configured to show how the scoring changes once incorporated. Dynamic scoring changes enable precise updates and/or development of pen-test unavailable in conventional approaches.

In further embodiments, the system also generates a web survey (e.g., three, four, five, etc. question web survey) that is embedded into the phishing test, which is then sent to a sample of IT professionals in the organization (e.g., other IT managers or experts who understand the level of phishing training users in the organization received). In one example, the system is used by an authorized user (e.g., IT manager) to send the sample phishing test along with the embedded survey to a selected group of participants (e.g., selection of IT staff). Responses to the survey can be captured by the system and analyzed to establish a threshold value that test subjects should be able to achieve.

In further embodiments, the system can be configured to deploy the phishing attack simulation to any other selected users (e.g., all the users in the organization) who are the subject of the test analysis. According to some embodiments, the system can embed survey questions into an attack vector, while in other embodiments, survey questions can be sent separately, and in yet others examples pen-tests can include some embedded questions and some separately sent survey questions.

In further embodiments, each phishing attack simulation includes a mechanism for diagnosing individual phishing vulnerability. For example, embedded within each attack vector (e.g., email's hyperlink or attachment payload) is a web survey. Responsive to selection of the phishing material (e.g., an attachment or embedded link) the web survey can open up—e.g., as soon as the individual clicks on the hyperlink or opens the attachment that is the “payload” in an email attack. In some embodiments, the survey utilizes 15-20 or any number up to and around 40-50 questions that are designed to assess why the individual clicked on the phishing email. In some examples, those users who did not select within the phishing attack are sent a separate email with the same instrument with a few additional questions measuring why they did not open the phishing email. In various embodiments, the system tracks in real time successful attacks (e.g., pen-tests), and monitors unsuccessful vectors. After a period of time, the unsuccessful vectors are used to send follow up surveys to the non-susceptible users. As discussed above in some embodiments, all users, who click on the link and fall for the simulation including those who don't are sent the web survey (which can be up to or more than a week) after the simulation.

In further settings, actual receipt of the simulation can be tracked to ensure a vector did not fail because it was never viewed, it was filtered, etc. Such additional monitoring can increase the accuracy of any threat assessment.

Example Attack Scoring and Threshold:

In various executions, the system generates a phishing penetration-test (“pen-test”) using the Vishwas Triad framework, and in conjunction with the test the system develops a priori quantitative estimate of the test's performance. In one example, the system captures estimated information of how general users in the organization would score on the phishing pen-test from having a small sample of IT personnel answer a few (3-5) questions about the test. Some example questions include: questions to measure the expectations from the phishing test: e.g., how suspicious any average user in the organization would be about the veracity of the phishing pen-test (e.g., scored 0-10 from not at all suspicious to very suspicious); and how suspicious they themselves were about the phishing pen-test, (e.g., scored from 0-10, not at all suspicious to very suspicious). Another question that can be used in a priori estimation includes a question that measures perceived similarity or difference of IT personnel from the average user. In some examples, this question helps assess whether expectations are valid reflections of the users' in the organization (and for example, if they are better, worse, and/or the same). In some executions, the system can capture independent answers from anywhere from one to a dozen (e.g., or more) IT staff members (what we term as an expert sample). The responses are weighted by their perceived similarity with the target user population and the overall score of the respondents is used to determine an overall baseline expectation from the users in the organization subjected to the phishing test—in other words, identify what a typical user should score in response to the phishing pen-test.

According to further embodiments, the system is configured to execute the pen-test to the users in the organization. In some examples, the system is configured to manage the sending of the test and tracking of which users open the phishing email, where they clicked within the e-mail, when, how, and any other available metadata available on the user's selection (e.g., user location, timing, hours into shift, etc.). The system is configured to communication a cyber risk survey (CRS) in conjunction with the pen-test (e.g., 15, 20, 30, 40 questions, among other options). In some embodiments, users' operations on a pen-test will trigger an embedded hyperlink or attachment in response to a successful attack. The hyperlink or attachment can be configured to present a survey (e.g., a web survey). In other examples, within a week after the pen-test delivery, the targeted users are sent a survey (e.g., a web survey).

The survey questions are designed to measure the cognitive-behavioral factors that lead to individual phishing responses (whether successful or not). In one example, the survey utilizes 15 questions that measure the reasons for the individual's victimization.

In various embodiments, these factors and their measures were developed at least in part, using a series of phishing tests conducted in different organizations. The resulting model is referred to as the SCAM model (i.e., the Suspicion, Cognition, Automaticity Model), which comprehensively explains why people fall prey to phishing. In some embodiments, the model identifies the core factors on which to base an assessment.

On evaluating the model, a series of questions can be included that provide the most valid predictors of each causative construct. In various implementations, the questions include questions meant to pinpoint how suspicious the user was about the veracity of the phishing email. In one example, the user is presented questions to establish a score on a 0-10 scale from 0 not at all to 10—highly suspicious.

In further embodiments, the system generated questions can include measures for heuristic processing (e.g., 3 questions), systematic processing (e.g., 3 questions), cyber risk beliefs (e.g., 5 questions), habits (e.g., 3 questions), deficient self-regulation (e.g., 3 questions), and user email routines/patterns (3 questions).

For example, the questions measure the degree of cognitive involvement and effort based on the extent of heuristic processing (individual questions measure if the phishing email had familiar visual elements, whether the elements were consistent with other emails, and if the email elements were as expected, and such). In another example, the questions measure the degree of cognitive involvement and effort based on the extent of systematic processing (such as whether the user thought about the actions they took after looking at the email, made connections between the email's request and other information they knew about, and if they tried to connect the email request to other emails they had experienced, and such). In yet another example, the questions measure the degree of cognitive involvement and effort based on the extent of the individuals' beliefs about the inherent risks of their actions or their cyber risk beliefs (such as what the user thought were the inherent risks of malware on a mobile device and a computer, a hyperlink in an email and an attachment, different operating systems, and such). The survey questions can be configured to also assess the users' email habits (such as whether the individual reactively, frequently and automatically checks emails) and routines (such as whether email use is part of their work routines, is based on some conscious pattern, etc.). Further options includes questions to establish the extent to which certain actions they performed were stemming from their habitual email use or their routinized reactions to most emails.

In further embodiments, the system can score the individualized CRI—Cyber Risk Index. For example, using empirically determined beta weights and the SCAM model based linkages, the data from the surveys are combined to develop an individualized CRI. In another example, using responses to the question measuring each user's level of suspicion (scored 0-10), the system develops an individualized CRI.

In some embodiments, the CRI scores for each user ranges from 0-100 and there is an idealized cut off that is derived based on the a priori assessment of the phishing test (e.g., done by an IT expert sample survey). In various embodiments, the score provides an immediate, quantitative reference point to estimate the individual employee's cyber risk from phishing. In some embodiments, this scoring helps the system compare employees against others as well as aggregate and contrast different divisions with organizations or different organizations across sectors in their risk from such cyber incursions. In further embodiments, an overall organization cyber vulnerability score is also generated by deducting the percentage of individuals within the organization that exceed the baseline from the percentage who meet or fall below it.

In some embodiments, execution can include diagnostic analysis of reasons for individual vulnerability: having generated a CRI (e.g., by the system) for the individual and an overall vulnerability score for the organization, various embodiments reduce the information to why users are vulnerable. Making this information available and derivable represents functionality that no other current methodology to assess spear phishing vulnerability presently achieves. In some embodiments, the execution utilizes the baseline cut-off score discussed above to parse out the low and high-risk individuals. Their responses (e.g., to a cyber risk survey “CRS”) provides the individual values on each factor—that is, their risk beliefs, heuristics, systematic processing, habits, and such—and allows the system to examine them. According to some embodiments, deviations in the scores between the high and low risk individuals are used to diagnose and pinpoint the cognitive-behavioral reasons for their phishing victimization.

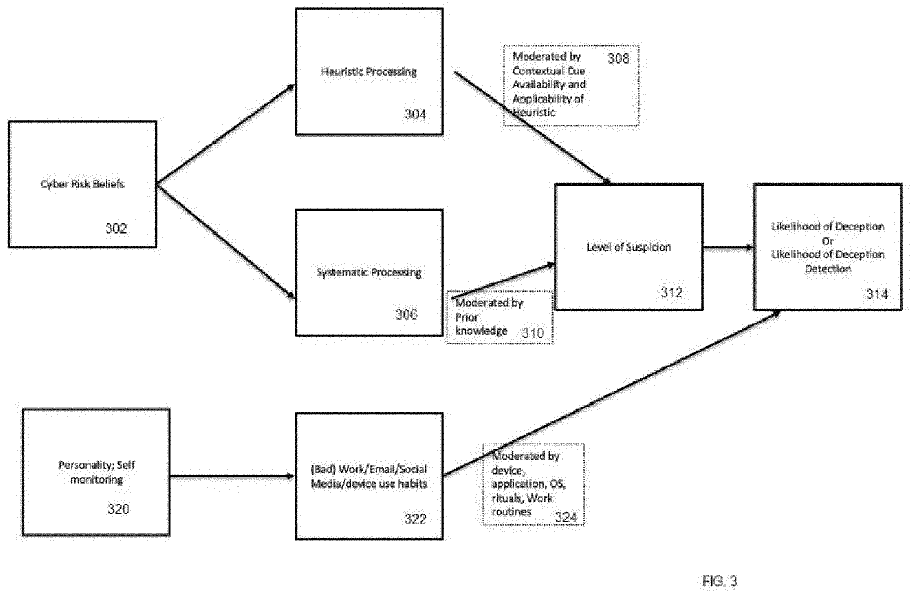

FIG. 3 shows conceptual elements for scoring users as part of vulnerability analysis and/or pen test execution. Scoring can begin with assessment of a user's of the cyber risk belief at 302. Cyber risk beliefs are assessed based on response to the CRS where questions assess the strength of the user's beliefs about the inherent risks of their online actions For instance, questions measure if the user beliefs a certain operating system is safer than another, a certain file type is safer, among other examples. According to one embodiment, the assessment of risk belief can include heuristic processing at 304 to determine if the attack had familiar elements. According to some embodiments, the assessment of risk belief can include a systematic processing assessment at 306, to determine whether the user thought about the actions they were taking with respect to the attack and/or whether the user thought the attack had connection to other emails or other actions they normally take.

Another scoring factor can include a level of user suspicion when participating in the attack simulation at 312. In some embodiments, scoring variables can include a likelihood of deception for given attack or a likelihood of deception/detection of a given attack at 314. The likelihood can be established based on the sample population run of the test, among other examples. In addition to the above scoring factors, individual scoring factors may also be included. For example, scoring for personality or self-monitoring activity (e.g., 320) can be used to modify a vulnerability score. In some embodiments, this can include information on normal work habits and/or bad work habits (e.g., accessing external email, social media, normal device use, Internet and access, etc.) at 322.

According to various embodiments, the scoring can be moderated such that additional independent variables can influence the relationship of various scoring elements and/or define a strength of a relationship between scoring elements. In one example, heuristic processing can optionally be moderated by types of cues or information signals present in an attack simulation. Shown in FIG. 3, heuristic processing can optionally (shown in dashed box) be moderated by contextual cues, the presence or absence of cues, among other options (e.g., at 308). At 310, optional moderators can be used as part of regression analysis and, for example, systematic processing 306 can be moderated by a given user's prior knowledge and/or experience in the context of the simulated attack. According to another embodiment, use habits at 322 can be moderated by a type of device (e.g., mobile or desktop, among other options), the operating system, the email/client application, and/or established work routines, among other options. According to various embodiments, regression analysis of user scores and/or scoring elements can incorporate a beta weight based on respective moderators, and the user's ultimate score will reflect any independent variable incorporated in the regression.

According to various embodiments, in addition to each individual's CRI that quantifies the user's level of cyber risk, the diagnostic also records and reveals the reasons for their risk. In some embodiments, the system can generate a unique data structure, linking individual CRI scores to associated reasons for susceptibility. The data structure can provide targetable information on reasons for specific scores that can be translated by the system into respective training or education options for correcting vulnerability. In some settings, systematic execution can be used to identify attack vectors matching a given user's vulnerability, and the system can highlight those vectors (e.g., e-mails) to alert the respective user to the potential risk and vulnerability. In further examples, such vectors can be segregated or quarantined for further review, or even made viewable in non-executable spaces (e.g., attachments are sandboxed for opening view only (e.g., limiting potential attacks, etc.)).

According to various embodiments, the scoring and/or data structure, etc. allows the system and/or IT managers/admins to identify not only the weak links in the organization but also determine what types of interventions are necessary. This represents a significant advance over current mechanisms of providing the same training to everyone regardless of whether they need it or not and regardless of what type of training they need. The system enables functionality unavailable in conventional approaches based on the determined scores. Further embodiments help an organization track the effectiveness of training and other improvements provided to the individual employee overtime. This approach yields significant executional efficiency relative to conventional systems. It also leads to improved allocation of training resources and a graduated, quantified assessment of individual and organizational readiness.

Various embodiments resolve conventional issues associated with the lack of mechanism for designing the “appropriate” phishing vectors (e.g., email) and for developing a baseline. The inventors have realized that lack is an issue because a poorly designed phishing pen-test, one that appears too authentic, or one that is too easy to spot as a fake, skews the results and limits the accuracy of any captured data. Further consistency in the assessed vulnerability (e.g., designed using model and threshold risk scores (e.g., upper and lower thresholds) enables the system to compare multiple iterations of phishing simulations effectively and accurately (which, for example is unavailable in current approaches). In various embodiments, developing a phish based on the framework (including Vishwas Triad framework) ensures that the resultant data from the phishing tests are valid reflections of individual susceptibility. According to various aspects, there is no single phishing email that is relevant for all organizations or users—“no one size fits all.” Hence, having the phishing pen-test scored a priori by an IT “expert” sample from within the same organization on which it is subsequently tested provides a quantitative assessment of the quality, appropriateness, and relevance of the phishing test for users in that organization. In doing so the system quantitatively ascertains each pen-test and fits the test to the users in each organization on a customized basis. Additionally, the further simulations are susceptible to accurate comparison having been developed with similar risk scores and factors.

Various embodiments provide additional functionality for which there is no conventional analog—there is no current diagnostic that provides any understanding of how or why people fall victim to spear phishing attacks. The system and methodology (and for example, the associated measurement technique) enables the system to determine that people fall victim to phishing but also how and why they were vulnerable.

Various examples resolve the lack of metrics for quantitatively assessing human cyber vulnerability to phishing attacks regardless of kind or nature. The CRI and associated data structure are unique. In various embodiments, the system executes a set of measures that are designed to tap into the cognitive-behavioral predictors of individual victimization and link such phishing activity to particular vulnerabilities which can be based on the SCAM model.

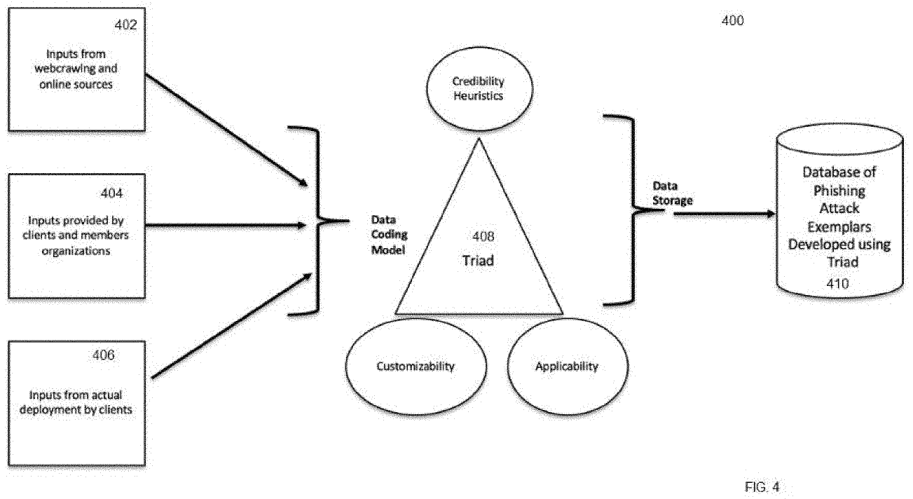

FIG. 4 is a block diagram of an example embodiment of an assessment system 400. According to some embodiments, FIG. 4 illustrates how the assessment system will populate, organize, and manage attack simulation data. As shown, the system is configured capture data from multiple sources. For example, the system can be configured to capture data using web crawling processes (e.g., 402). The web crawler can capture information on phishing attack reports. In various examples, phishing attacks are reported in the media, online, in open source portals, and also by reporting organizations who publish vulnerability information.

According to other embodiments, other data sources that can be captured include reporting by system clients and/or member organizations at 404. For example, system clients can report failed attacks as well a successful ones, and information on both can be incorporated for downstream attack simulation. In another example, captured data sources can include information on execution of simulated attacks and their results. In various embodiments, each of the information sources can be coded according to the scoring triads (e.g., on credibility heuristics, customizability, and/or applicability, among other options) at 408.

According to one embodiment, once the data streams are captured and coded the information can be stored in database 410. For example, database 410 can capture phishing attack exemplars, their characteristics, attack simulation examples, and their characteristics. According to some embodiments, the collection of attack information provides a feedback loop for scoring and capturing components for generating new attack simulations.

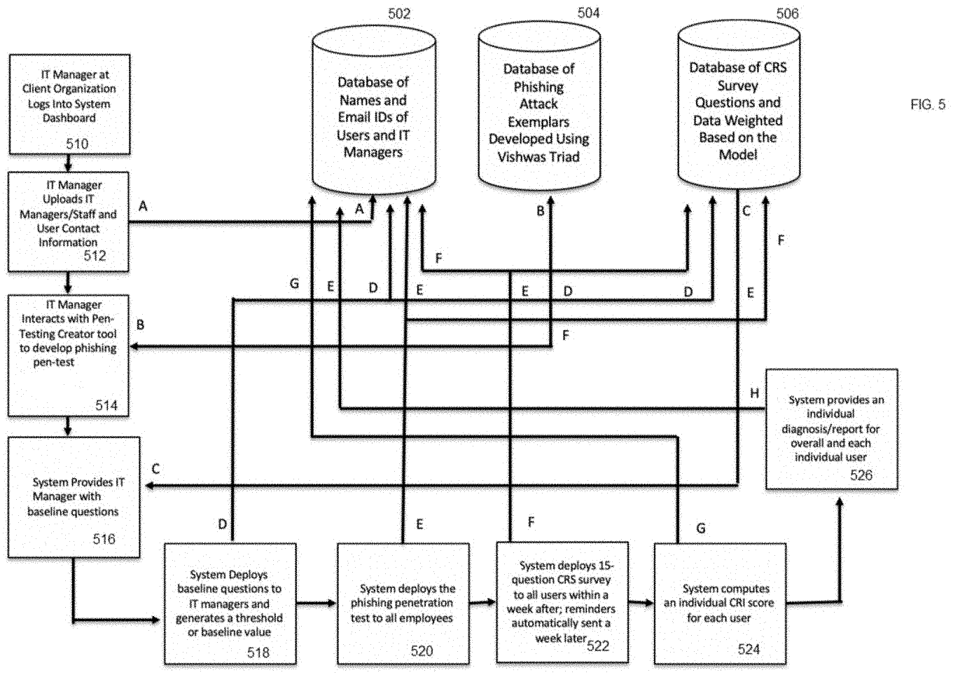

FIG. 5 illustrates example system components and process flow steps for generating an individual report and/or risk assessment for respective users. According to one embodiment, an assessment system can include multiple databases. For example the system can include a database of names and identifying information for a given entity or participating organization at 502. In another example, the system can include a database of attack simulation examples (e.g., at 504). In some embodiments, the system can also include a database of survey questions and weighting data for defining relationships between scoring elements (e.g., at 506).

According to some embodiments, users can access the system and, for example, an IT manager at a client organization can log into the assessment system at 510. In some examples, the user will be shown a dashboard for submitting contact information for a user population and/or creating a pen-test for execution.

For example, at 512 the user can upload identifying information for their user population. Shown in FIG. 5, the user can interact with the system to create an attack simulation at 514. Based on the selections made during generation of the attack simulation, the system can be configured to provide the user with a set of baseline questions that will elicit information on user susceptibility to the attack simulation (e.g., 516). In some examples, the system generates a three question baseline survey. In other examples, differing numbers of questions can be used.

According to some embodiments, the generated attack simulation is executed against a sample population to establish baseline scoring values (e.g., 518). For example, the attack simulation can be run on an IT department or any other group of users. Once a baseline score is established, the attack simulation can be sent to a different population of users (e.g., 520).

As part of execution of the attack simulation on the different user population a follow-up survey is sent to all participants of the attack simulation at 522. Various reminders can be sent until completed responses are received. According to various embodiments, based on user performance during the testing and the received responses to the survey questions, an individual vulnerability score is computed for each user at 524. According to some embodiments, an individual report can be generated based on their actions during the simulation and based on their survey responses at 526. Individual reports and/or assessments can include identification of training that should be executed by a respective user to improve vulnerability score.

According to some embodiments, vulnerability scores falling within certain thresholds may trigger automated action by the system. Optionally, high-risk users may be subject to changes in permission, changes to access rights, functionality lockouts, Internet restrictions, enhanced security measures, behavior profiling, etc.

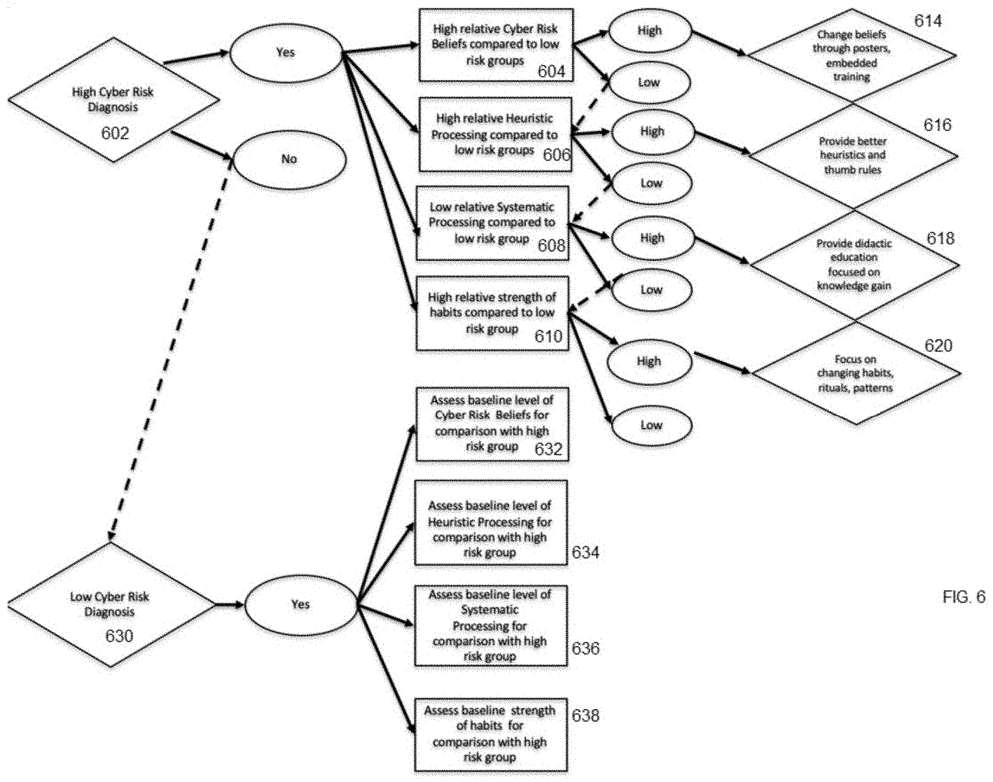

Shown in FIG. 6 is an example logical flow for developing training options based on user risk assessment. For example, if the user is identified as a high cyber risk at 602 YES, a variety of assessments can be made against risk categories. According to some embodiments, the various risk categories that can be analyzed include determining if the respective user has high relative cyber risk beliefs in comparison to a low risk group at 604. Further analysis can include determining if the respective user has a higher relative heuristic processing score compared to low risk groups at 606. Additionally analysis can also include determining if the user has a low relative systematic processing score compared to a low risk group at 608. Further analysis can also be performed to determine if a user has a high relative strength of habits score compared to a low risk group at 610.

According to some embodiments, if the risk category analysis determines that the respective user performed well relative to the low risk group, no further training options are selected. For any category that the respective user is determined to be at higher risk relative to the low risk group, tailored training options can be selected. For example, at 614 training exercises configured to change beliefs for user perception of cyber risk can be identified by the system. Such training exercises can be specifically tagged in a database of training exercises and/or can be identified over time based on users improving their cyber risk score with respect to cyber risk belief. According to another example training exercises configured to provide better heuristic processing and to establish better user behavior for heuristic processing can be selected by the system at 616. Similar to cyber risk belief exercises, heuristic training can be identified by the system based on tagging associated with training exercises and/or can be tagged by the system based on historic performance of improving user scores relative to heuristic processing. At 618, the system can optionally identifying training exercises configured to provide didactic education focused on knowledge again to facilitate improvements in systematic processing scores. In yet other examples, at 620 training exercises configured to focus users on changing habits developing better rituals and improving use patterns can be selected.

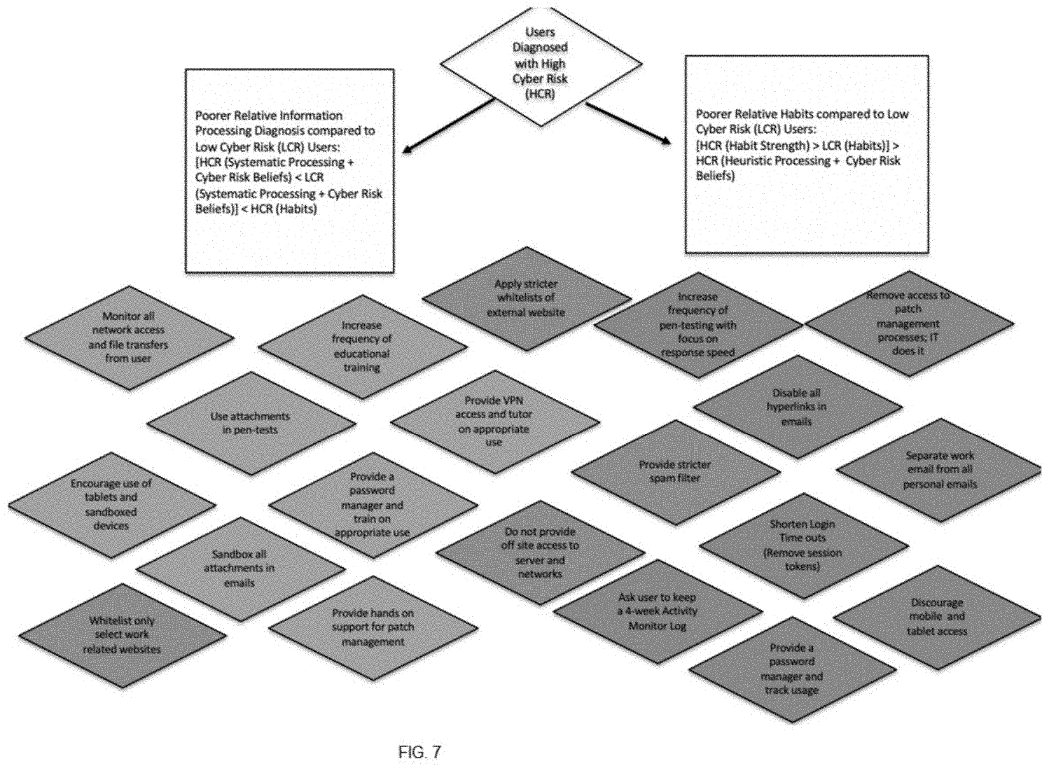

According to various embodiments, users with low cyber risk scoring (e.g., 630), can be used to establish and/or modify baseline scoring. The baseline scoring can be used to determine relative performance between high-risk and low-risk users. According to some embodiments, a training selection process can include determining a baseline level for cyber risk belief at 632, assessing a baseline level for heuristic processing at 634, assessing a baseline level for systematic processing at 636, and/or assessing a baseline score for strength of habits at 638, among other options. FIG. 7 illustrates approaches for identifying high risk users, and identifying training options/interventions for respective users. The examples illustrated in FIG. 7 can be determined by various embodiments, however, other embodiments, can identify different interventions and/or training options and/or tag additional training options responsive to identifying improved user performance.

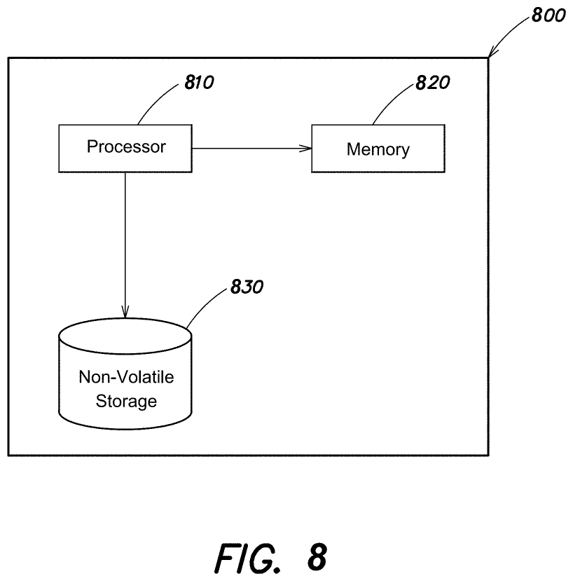

An illustrative implementation of a computer system 800 that may be used in connection with any of the embodiments of the disclosure provided herein is shown in FIG. 8. The computer system 800 may include one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner. To perform any of the functionality described herein, the processor 810 may execute one or more processor-executable instructions stored in one or more non-transitory computer-readable storage media (e.g., the memory 820), which may serve as non-transitory computer-readable storage media storing processor-executable instructions for execution by the processor 810.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to FIG. 3) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A system for identifying vulnerability to phishing attack, the system comprising:
at least one processor operatively connected to a memory storing instructions, the instructions when executed cause the at least one processor to perform functions to:
manage generation of a penetration test (“pen-test”);
evaluate the pen-test during generation, wherein evaluation of the pen-test includes functions to:
score the pen-test on a plurality of factors;
execute the pen-test on a sample of users;
collect evaluations of the pen-test from the sample of users;
generate a baseline score for a user population based on the collected evaluations;
execute the pen-test on the user population different than the sample of users;
identify underperforming users within the user population as not meeting the baseline score; and
execute custom training on the underperforming users.

2. The system of claim 1, wherein the system executes subsequent pen-tests on the user population and evaluates performance of the underperforming users responsive to executing targeted training to improve performance.

3. The system of claim 1, wherein the system is configured to correlate underperforming users and identify reasoning for underperformance based on user survey responses.

4. The system of claim 3, wherein the system is configured to select training options correlated with the reasoning for underperformance.

5. The system of claim 4, wherein the system is configured to determine an efficacy of the training options based on subsequent executions of pen-tests.

6. The system of claim 5, wherein the system is configured to automatically select different training options based on determining insufficient improvement over time.

7. The system of claim 1, wherein the plurality of factors include: (i) how credible is a sender of an email to the end-user; ii) how easily identifiable are cues indicating credibility of a source; and iii) how routine does a request appear in context of an organization.

8. The system of claim 1, wherein the at least one processor is further configured to automatically update security permissions on accounts associated with underperforming users.

9. The system of claim 8, wherein the at least one processor is further configured to automatically update browser privileges for respective underperforming users including at least one of increasing security filtering for web browsing, limiting access to whitelist websites, or preventing access to blacklist websites.

10. The system of claim 8, wherein the at least one processor is further configured to automatically update application privileges associated with respective underperforming users including at least one of increasing security settings for e-mail filtering, increasing periodicity of virus scanning, activating port monitoring on respective underperforming users, activating behavior profiling, increasing frequency of any monitoring, isolating e-mail attachments to prevent executable function, or monitoring for executable functions triggered by e-mail attachments.

11. The system of claim 8, wherein the at least one processor is further configured to restore security permissions responsive to user completion of identified training operations.

12. The system of claim 8, wherein the at least one processor is further configured to restore security permissions responsive identifying a risk score improvement meeting a threshold level.

13. A computer implemented method for identifying vulnerability to phishing attack, the method comprising:
managing, by at least one processor, generation of a penetration test (“pen-test”);
evaluating, by the at least one processor, the pen-test during generation, wherein evaluation of the pen-test includes:
scoring, by the at least one processor, the pen-test on a plurality of factors;
executing, by the at least one processor, the pen-test on a sample of users;
collecting, by the at least one processor, evaluations of the pen-test from the sample of users;
generating, by the at least one processor, a baseline score for a user population based on the collected evaluations;
executing, by the at least one processor, the pen-test on the user population different than the sample of users;
identifying, by the at least one processor, underperforming users within the user population as not meeting the baseline score; and
executing, by the at least one processor, custom training on the underperforming users.

14. The method of claim 13, wherein the method further comprises executing subsequent pen-tests on the user population and evaluating performance of the underperforming users responsive to executing targeted training to improve performance.

15. The method of claim 13, wherein the method further comprises correlating underperforming users and identify reasoning for underperformance based on user survey responses.

16. The method of claim 15, wherein the method further comprises automatically selecting training options correlated with the reasoning for underperformance.

17. The method of claim 16, wherein method further comprises determining an efficacy of the training options based on subsequent executions of pen-tests.

18. The method of claim 17, wherein the method further comprises automatically selecting different training options based on determining insufficient improvement over time.

19. The method of claim 13, wherein the at least one processor is further configured to automatically update security permissions on accounts associated with underperforming users.

20. The method of claim 19, wherein the at least one processor is further configured to automatically update application privileges associated with respective underperforming users including at least one of increasing security settings for e-mail filtering, increasing periodicity of virus scanning, activating port monitoring on respective underperforming users, activating behavior profiling, increasing frequency of any monitoring, isolating e-mail attachments to prevent executable function, or monitoring for executable functions triggered by e-mail attachments.
